(19) United States
(12) Patent Application Publication
(10) Pub. No.: US 2009/0070152 A1
(43) Pub. Date: Mar. 12, 2009

(54) SYSTEMS AND METHODS FOR DYNAMIC QUOTE GENERATION

(75) Inventors: Jason I. SPERSKE, Hayward, CA (US); Timothy J. Bellig, Danville, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Rolling Solutions LLC, Danville, CA (US)

(21) Appl. No.: 12/207,275

(22) Filed: Sep. 9, 2008

Related U.S. Application Data
(60) Provisional application No. 60/971,856, filed on Sep. 12, 2007.

(51) Int. Cl. G06Q 40/00

(52) U.S. Cl. 705/4

(57) ABSTRACT

Accurate quotes can be generated using a dynamic approach to obtaining information. A set of questions can be generated to be displayed to a user. At least some of the questions can be evaluative questions, such that when an answer is received that answer is analyzed and the set of questions can be updated based upon the answer as determined by various business rules, etc. Once all answers are obtained, the answers are analyzed using a database of quote information and a set of quotes can be generated automatically. Information such as the carrier for each quote can be withheld such that the user is not able to independently use the quote to buy a product or service, and a user also can be prevented from going back and changing answers to the various questions in order to adjust the quotes displayed.

### CROSS-REFERENCE TO RELATED APPLICATIONS

This application claims priority to U.S. Provisional Patent Application No. 60/971,856, filed Sep. 12, 2007, entitled “SYSTEMS AND METHODS FOR DYNAMIC QUOTE GENERATION AND ANALYSIS,” which is hereby incorporated herein by reference.

### BACKGROUND OF THE DISCLOSURE

In insurance and other such industries, an agent might call a broker with specific details for a potential customer, and ask for a rate quote or rate class taking into account those specific details. For example, an agent might call a life insurance broker and ask for a quotation for a 45 year old male with diabetes who smokes. The broker, who might represent or work with a number of insurance carriers, then needs to know accurate and up-to-date information to generate a quote using those details for each carrier in order to provide accurate quotation information and to be able to provide what is likely to be the lowest cost and/or highest amount of coverage available. In previous systems, the rules and parameters for each insurance company were kept in binders, such that the broker would need to page through all the binders to find the relevant information. Not only are these binders extremely thick and complicated, but they are constantly updated so that it is virtually impossible for anyone to know all pertinent and up-to-date information in the binders. Further, while experienced employees may have acquired knowledge that allows them to quickly navigate the binders and know which companies to exclude for certain parameter values, for example, this information cannot easily be passed on to other employees or trainees.

Further, there is a desire for consistency between quotes. A person having made a complicated quote a couple of weeks ago would like to be able to remember, access, or utilize information from the previous quote to provide an accurate and consistent quote for similar parameters. In the past, this would require going back through voluminous records in addition to navigating the binders to see if any rules have changed.

Because the amount of information can be overwhelming for any one person, or where very accurate information is needed, the broker might contact each insurance company individually with a set of parameters to get quote information for each carrier while ensuring that information from one carrier does not make it to another carrier. In some systems, this involves sending information for a “quick quote,” using a snapshot of a person's medical history without their name included in order to obtain in a blind, informal way a somewhat accurate quote for that person. While such an approach is likely to provide relatively accurate information for each carrier, it can take a day or two to accumulate the information for each company. In today's world, particularly where quotes can be requested online where almost immediate feedback is expected, waiting a two or three days to provide results can cause the customer to go elsewhere or at least look at other sources or providers.

Further, oftentimes when a quick quote is provided, such as online or over the phone, there is no way to determine if that quote actually resulted in a purchase or transaction. Since identity information is not included for the customer, there typically is no way to tie the quote to any subsequent order. There then is no way to accurately report or analyze the success of various quotations in order to better serve future potential customers.

Further still, since a potential customer provides information without an identity, there is no way to determine other factors that might affect the pricing. For example, if the 45 year old male in the example above does not include the fact that he has cancer or recently suffered a stroke, the quote provided might not be anywhere close to the actual rate that the customer would ultimately receive.

It thus is desirable to provide a system that provides quick and easy access to quotation information for multiple sources.

It also is desirable to provide a system that can store and maintain up-to-date rules and information for the various sources.

It also is desirable to provide a system that can store and build on previous quotes to provide more accurate information.

It also is desirable to provide a system that can ask questions or prompt for information in a way that will provide all relevant information needed to provide an accurate quote, and tie that quote to a subsequent purchase, without including identifying information for the customer.

### BRIEF DESCRIPTION OF THE DRAWINGS

FIG. 1 illustrates an example of a questionnaire engine that can be used in accordance with one embodiment;

FIG. 2 illustrates an exemplary process illustrating the functioning of a search engine that can be used in accordance with embodiment;

FIG. 3 illustrates an exemplary login screen that can be used in accordance with one embodiment;

FIG. 4 illustrates an exemplary display detailing pending actions and logical future actions that can be used in accordance with one embodiment;

FIG. 5 illustrates an example of a screen showing a list of active agents that can be used in accordance with one embodiment;

FIG. 6 illustrates a sample screen showing an agent's clients that can be used in accordance with one embodiment;

FIG. 7 illustrates an exemplary display displaying quotes for a given client that can be used in accordance with one embodiment;

FIG. 8 illustrates an exemplary display of a customer information form that can be used in accordance with one embodiment;

FIG. 9 illustrates an exemplary display of tagged quotes that can be used in accordance with one embodiment;

FIG. 10 illustrates an exemplary sample display listing some general risk profile questions that can be used in accordance with one embodiment;

FIG. 11 illustrates a sample display of carriers that produce a match against supplied answers that can be used in accordance with one embodiment;

FIG. 12 illustrates a sample display of a carrier information that can be used in accordance with one embodiment;

FIG. 13 illustrates a sample screen listing matched and unmatched carriers and their email contacts that can be used in accordance with one embodiment;

FIG. 14 illustrates an exemplary display displaying a summary of the carrier's responses that can be used in accordance with one embodiment;

FIG. 15 illustrates an illustration of separation of information and demand that can be used in accordance with one embodiment;

FIG. 16 illustrates an example of a process for generating a quote that can be used in accordance with one embodiment; and

FIG. 17 illustrates components of an environment for implementing approaches in accordance with various embodiments.

### DETAILED DESCRIPTION

Systems and methods in accordance with various embodiments overcome the aforementioned and other deficiencies in existing quotation approaches by providing for the dynamic generation of quotations using rules and information from multiple sources. Such systems and methods also can provide for various evaluations and can track those evaluations and provide reporting.

In one embodiment, a user such as an agent, broker, or even potential customer accesses an interface such as a software application GUI or Web page to enter information to be used for a quote. The user will enter information for a series of questions, but the series of questions is not fixed. The questions presented to a user will be dynamically determined at least in part based upon answers to previous questions. These questions also can be determined in part based upon rules of the various carriers stored in, or accessible to, the system. In one embodiment, the system has over 500 questions and the user can be required to answer any number of these questions. The pattern of the questions thus is not a linear pattern or strict tree structure, but can be considered a tree where certain branches only become available upon answers at certain nodes. Further, an answer at a node might result in going “backward” through the tree and navigating a branch that was previously not available but that now is required for at least one carrier based on the answer at that node. Further, certain questions may only be required for certain carriers or providers.

The user interface also can display an approximate level or other indicator of progress through the question tree. For example, a basic tree might include 10 questions. When a user enters an answer for a first question, the progress indicator might display “10% complete.” The progress can change depending upon the answers and branches, however. For example, the answer to a second question might open up a branch with several questions to be answered, such that instead of going to “20% complete” after answering the second basic question the progress indicator might display “12% complete” or even “5% complete”, which would be less than the 10% previously displayed due to the amount of additional questions now needing to be answered. The interface also can allow going back and changing an answer in case the user decides that they probably should have answered a question differently.

A dynamic approach is advantageous not only because it can ensure that substantially all of the pertinent information is provided, but it also minimizes the amount of questions a user must answer to get an accurate quote. In other approaches, a user would have to read many questions that do not apply to the user in order to get an accurate quote. For example, a paper-based approach might include questions that ask if the user smokes, and if so how often, what type, etc. All these questions would be included on the paper questionnaire. In a dynamic system in accordance with various embodiments, if a user answers “no” to the smoking question then the user never sees the other smoking-related questions (unless they become activated as a result of another question, such as whether a parent or spouse smokes).

There also can be both evaluative and non-evaluative questions. In one embodiment, an evaluative question corresponds to a node of the structure. This can be a question such as “Does the customer smoke?” where the answer can determine whether a branch of smoking-related questions is to be displayed to the user. In the smoking-related branch also can be a non-evaluative question such as “How often?” which does not correspond to a node where multiple branches may exist, but will simply be answered and then the next question along that branch will be asked. In one embodiment, questions are always asked one at a time. In another embodiment, all connected questions are presented to the user at the same time in a single interface that expands and contracts as questions are answered, updated or deleted.

Once there are no more questions to ask for a potential customer, the progress indicator can display 100% and a new screen can be displayed indicating that the information is being evaluated by the system. In some embodiments the evaluation is done automatically after an answer is provided to the last relevant question, while in other embodiments the user must select a “search,” “submit,” or similar option. After evaluating the entered information, the system in one embodiment displays a number of classes found for the customer. Classes can also be displayed for multiple types of product, such as term and permanent insurance. A selection of one type can alter the number of classes displayed. The page also can display which questions were not answered for each class (or carrier) that might affect the reliability of the quote. In some embodiments, the evaluation might determine that a specific carrier has additional questions or rules, which the user might be able to access at this time in order to obtain an accurate quote for that carrier. Those additional questions can also affect the results for other carriers, and can reduce the number of classes displayed. The results returned by the search engine can then be sorted by any appropriate measure, such as a determined confidence for each carrier. An example confidence sort promotes carriers with the most consistent underwriting history (factoring historical performance), the most transparent guidelines (factoring their Risk Meta Language (“RML”) profile), and/or other such proprietary factors.

In one embodiment, a developer interface is provided that allows non-programmers to define the questions, nodes, and branches based on current rules and guidelines. A development language is provided that allows people to express arbitrary questions and assign the questions to arbitrary classes of insurance or other products, for example. The logic in the system then can determine which question to provide next based on the answers, classes, etc.

If the quote to be generated at the end of the input process is for a small to medium size account, for example, then this quotation process may be sufficient, as the actual cost should not be significantly different. For high-dollar policies, however, it can be desirable to ensure that the quotation is precise and not based on past quotes or potentially old rules or classes. As such, there can be an option to email the answers to the appropriate carrier(s) and wait for a response before providing an answer. This answer then of course will be more accurate, and high-dollar accounts typically will be more willing to wait a certain amount of time for a precise answer. The system also can track the average response time for each carrier, and even to each individual employee of the carrier. This can help to not only decide to whom to send requests for quotation, but can provide valuable information to the carriers themselves.

When an agent answers all the questions for a customer and gets the answers, it is desirable in at least some embodiments to prevent the agent from simply going directly to the carrier and cutting out the entity that provided the agent with that information. One way to do this is to provide the rate and/or class information, but not indicate to the agent the carrier associated with that information. In this way, the agent must come back to the entity to purchase the product or service at that rate. Also, a user is not able to go back and edit certain information in an attempt to get a better rate by providing different answers to the questions (such as to reduce the frequency of smoking). Further, all the requests and responses can be linked to the information so that it can easily be tracked, analyzed, and reported on.

By analyzing the information and results, such a system can begin to “learn.” The system can interpret the relevance of that certain information, and when a carrier disagrees with system information, the system records that discrepancy and starts analyzing the differences and establishing an accuracy graph. Such information can help an administrator of the system to understand why that graph was deviated from. As the system gets smarter, the number of email messages to obtain accurate information should decrease accordingly. The learning can be accomplished through use of a meta-language, for example, that allows the system to represent a carrier's underwriting guidelines without input from the carrier.

Further, after a questionnaire is completed and submitted, each of the facts can be compiled, cross-referenced, compared, aggregated, and otherwise analyzed. When the quotes are determined, this information also can be correlated with the facts. Reports then can be run to determine statistics and information for any set of facts, etc. For example, the system can provide information for users taking a particular drug, or having a certain condition, etc.

In one embodiment, the system is Internet-based and can provide interfaces that can be accessed using any Internet-browsing capable device, such as a desktop, laptop, cell phone, PDA, Blackberry, portable gaming device, or portable media device.

An exemplary software system in accordance with one embodiment is referred to in the following figures as “XRAE”. This system seeks to remove transactional friction in the informal and pre-application process in the Life Insurance industry, as well as increase visibility across the network to benefit brokerage agencies, marketing groups, and insurance carriers. Carriers attempt to expose their products across all levels of the marketing chain. However each level presents its own unique costs and challenges. Carriers are rapidly moving away from maintaining large in-house teams of Carrier Agents (agents who focus on selling a single company's products), and in an increasingly complex market, customers are no longer able to do the footwork themselves leaving the Brokerage Agency as the dominant interface that customers will have with an Carrier while searching for a product to purchase. In a recent Bureau of Labor Statistics report, 19.4% job growth is expected in the next 7 years in Brokerage Agencies. This migration is occurring primarily because of the costs associated with searching for business opportunities, both in finding customers as well as finding products that they might qualify for.

Carriers typically would prefer to only see prescreened, qualified and interested customers. In order to achieve this, Carriers often are willing to pay a commission to Brokerage Agencies in exchange for the Agency's efforts in prescreening and managing the potential customer. For their part, Carriers are able to compensate efficient Agencies enough to create a profitable operation and bare the weight of all the missed opportunities. As Carriers increase their product diversity and class complexity this margin begins to shrink. Add to this the reality that no current technology exists to help the Agency anticipate a Carrier's response, or utilize all of the rich data they acquire to better market their customers. Underwriting rules, which vary widely from Carrier to Carrier (and even in subtle ways from year to year as new conditions are tracked, or morbidity statistics are refined), have primarily resided inside the Carrier's own databases, and are disseminated only partially in the form of Underwriting Guidelines, company Web sites, and hundreds of thousands of emails sent to individual agents and agencies.

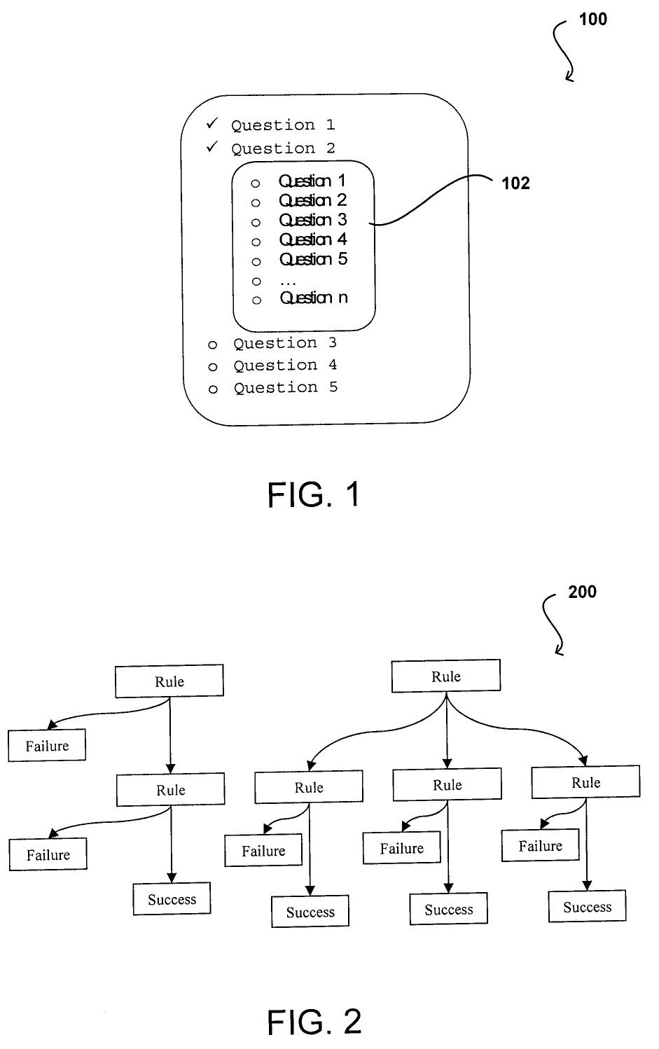

This system includes a platform where Carrier's insurance products (and classes) can be uniquely represented through the Meta language referred to herein as Risk Meta Language (RML), and Agents and Agencies can shop a customer instantly across all published classes of insurance to determine the best fit and the likelihood of success. On top of this platform is built a series of sub applications that allow for transmission of Customer quotes directly to the insurance Carriers, as well as track the success and failure rate of those quick quotes. An advantage to such an approach is the decoupling of customer data and underwriting rules. The use of a high performance search algorithm and dynamic and expressive language allow companies to be as diverse as they feel necessary in their product definitions and a Questionnaire Engine, which can be included in a computer device as discussed below, can sort out all missing information based on not just what carriers have requested, but also what information they have requested based on what information provided so far. The result of a dynamic sorting process is illustrated in the display 100 of FIG. 1, wherein a subset of questions 102 is selected to be displayed to a user based on an answer to a specific question.

While other systems might present a “rolling question” experience, a system in accordance with one embodiment is able to spawn multiple dependant questionnaires that instantly determine what each company needs to know for each individual customer as they provide information.

One exemplary system contains a powerful search engine that is able to rapidly evaluate quotes based on any amount of information. Because this engine is decoupled from a Risk Rule or similar database, it becomes possible to rerun any customer against any company from the instant they provide information and at any point in the future. This means after a Customer has been entered into XRAE, the Agency can instantly find all possible classes of insurance they would qualify for. This query can be executed even if the products in the database didn't yet exist at the time the customer showed up. If a Customer is successfully marketed a product, XRAE can track that Customer's opportunities and alert the Customer's Agent the very second a new and/or better product becomes available for which the customer would qualify. If a Customer passes on purchasing any product, XRAE can keep looking until a better opportunity arrives to help the Agent keep the opportunity open. Even better, the entire population of potential customers that never buy anything can be analyzed for statistical similarities which can form incredibly rich reports that represent new markets and/or new opportunities.

A Search Engine in one embodiment begins by grabbing a complete stack of published rules. These rules can be bound to each other in a parent child tree (and can be bound to specific parent outcomes) creating a logical representation of the underwriting process, such as is illustrated in the decision tree 200 of FIG. 2. Initially the engine starts out looking for any failure (generating a non preferred outcome of a rule with no children). As the engine executes each rule, it can switch from an exclusive operation mode to a permissive operation mode where failures are allowed as long as a single success can be determined. The change in operation mode is isolated to only child rules of the “switched” parent rule.

In their simplest form, rules in one embodiment are small sections of code that are bound to Questions which are passed though Evaluators. The Search Engine generates three kinds of output after it has finished searching an entire tree: Pass, Fail and Missing Information. At each point in the tree the Search Engine determines which outcome a Rule generates (more on that in the Rule Types section) or if the required questions have been answered to evaluate. Fail means that in at least one place in the tree a terminating Rule generated a non preferred outcome (providing that the terminating Rule wasn't being tracked by a parent Rule while in the permissive search mode). Pass is only generated if every terminating Rule generates a preferred outcome. Finally Missing Information is generated when at least one Rule cannot find an answer to a required question and there are no failures generated at any other terminating Rules.

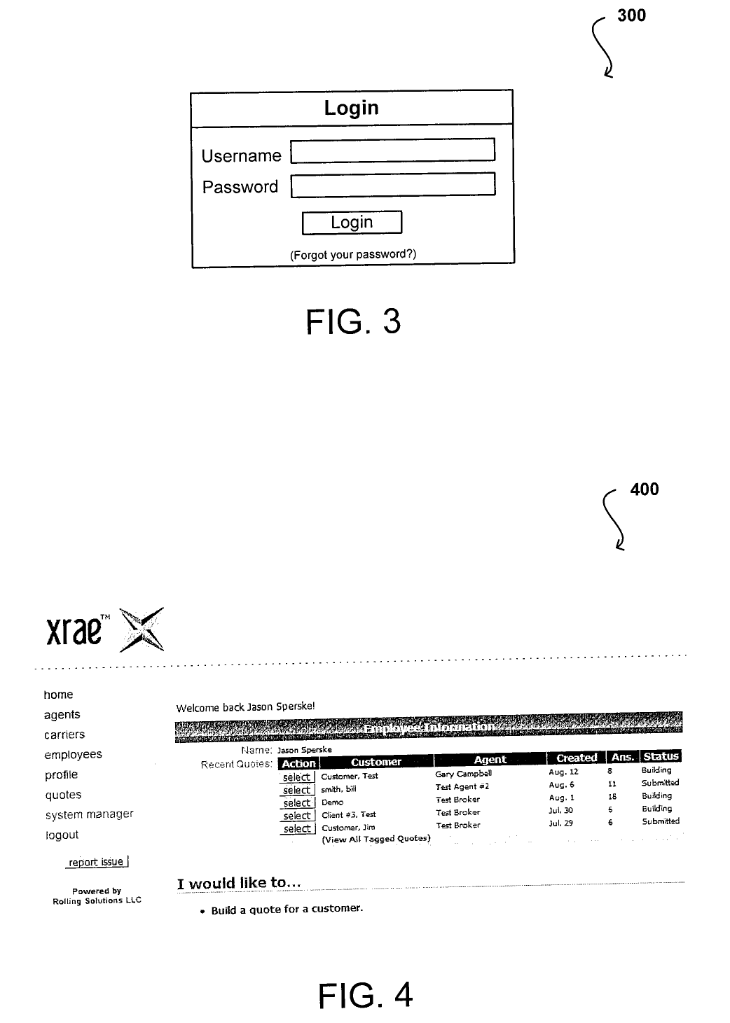

The displays of FIGS. 3-14 will be used to describe functionality that can be used in various systems and in accordance with various embodiments. These displays are merely examples used for purposes of explanation, and various other interfaces and approaches can be used as would be apparent to one of ordinary skill in the art in light of the teachings and suggestions contained herein.

A login screen 300, such as is shown in FIG. 3, is a secure gateway that can be used to gain access into XRAE. The application is distributable so that each interface can reside on physically separate servers and even inside intranets with limited access to the Internet (requiring only firewalled access to send email messages for communication, for example, as well as secured access to receive updates). This greatly reduces potential attack vectors. FIG. 4 illustrates a model for a page 400 that can serve as the instant overview of pending actions, and logical next actions, which can be presented to a user after gaining access through the gateway.

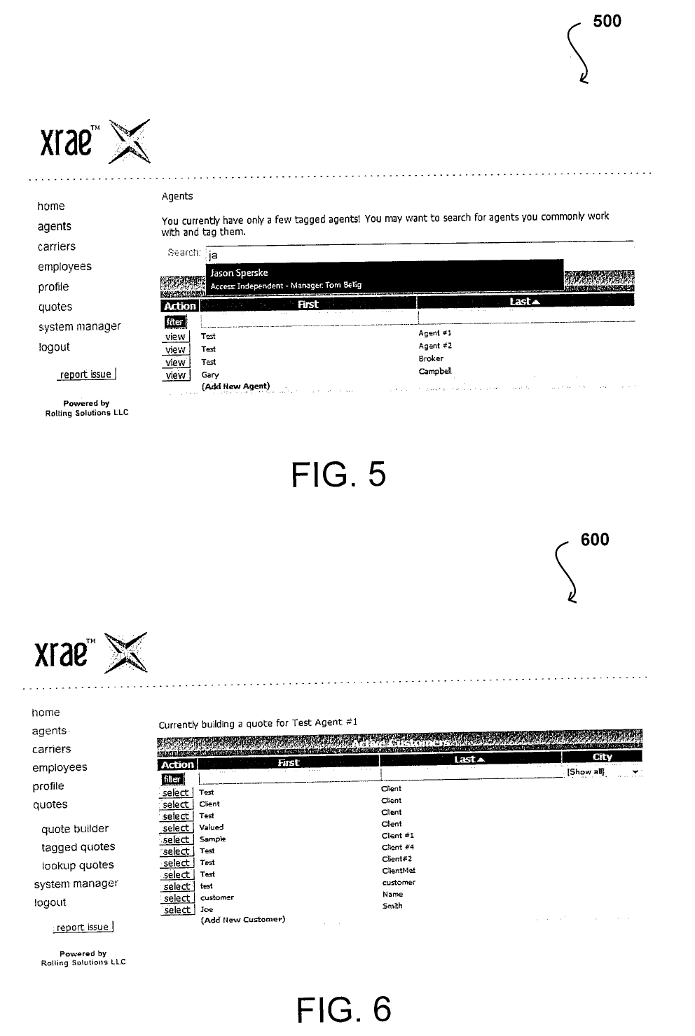

Each Agency can maintain a list of active agents 500, such as is illustrated in FIG. 5, who agree to utilize them as their primary Agency. XRAE memorizes who each user commonly works with and presents a list of tagged agents to simplify quote building, while also allowing any user to do a quick inline lookup of their entire agent list.

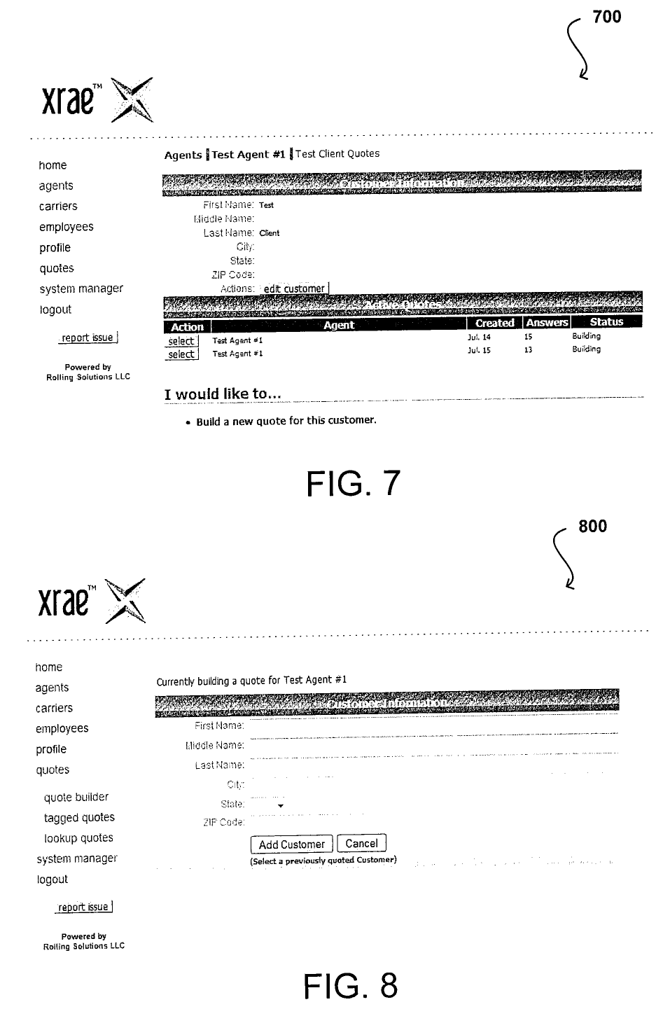

Each Agent will be able to track their own customer data, such as is illustrated in the exemplary display 600 of FIG. 6. A single Customer can have multiple quotes generated, as illustrated by the active quotes listed in the example display 700 of FIG. 7, representing multiple conversations or attempts to market that Customer.

Any appropriate information can be entered to identify a customer. At least some of the fields are optional and can later be refined, such as through a customer information entry screen 800 as illustrated in the example of FIG. 8. After a Customer is entered into the system, the customer is assigned an a anonymous ID so any future communication can be linked back to the customer's XRAE profile without sharing personal information, and as Personal information is discovered it can be shared instantly to anyone who has access to their profile.

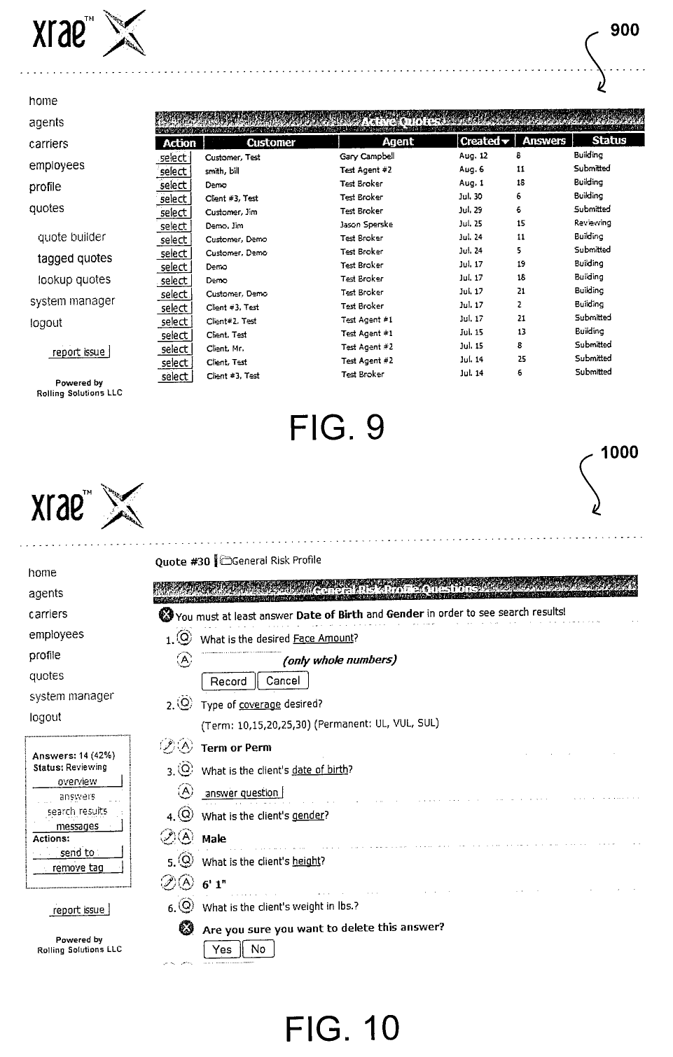

As an Agent builds quotes, the quotes are automatically tagged to the Agent for quick retrieval, such as is illustrated in the exemplary display 900 of FIG. 9. At any point Agents can remove their tag to a quote and other authorized users can tag the quote to themselves. Tags are not exclusive so more than one user can track the same quote or customer.

Reviewing several answers to multiple questions is enabled for at least some authorized users, such as is illustrated by the example display 1000 of FIG. 10. Related questions appear nested inside their parent questions.

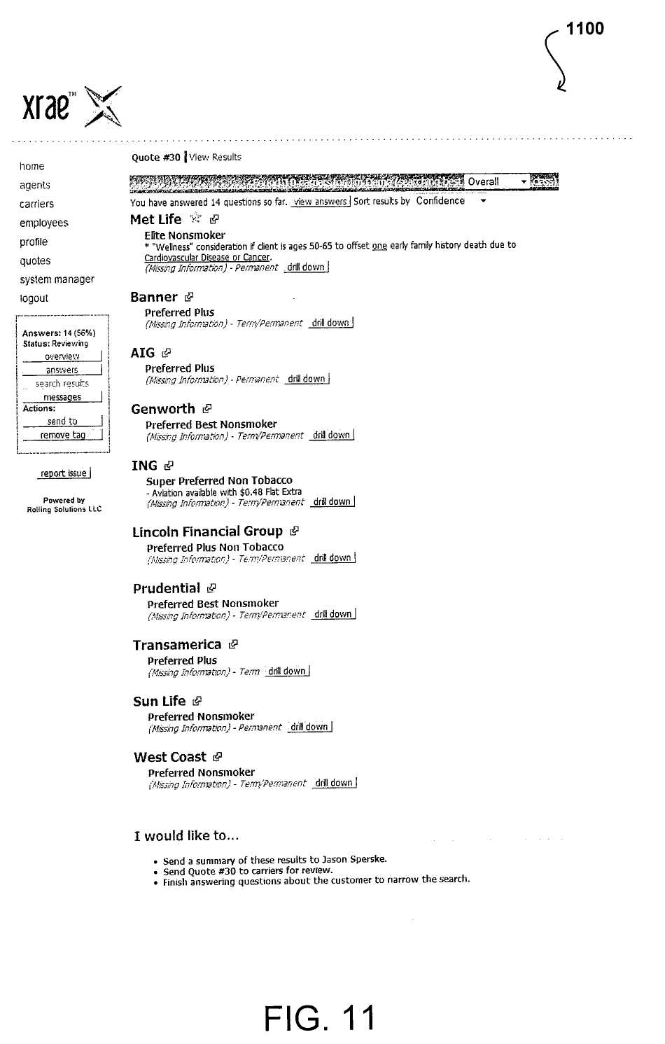

Search results can be displayed after the quote has been processed. Each carrier that is capable of producing some kind of match against the supplied answers is presented. Links can be provided to field underwriting guides or other online resources, such as is illustrated in the example display 1100 of FIG. 11. The “drill down” button links to a custom questionnaire built only out of the questions that a carrier has provided rules against that not already been answered as part of the general questionaire. This questionnaire represents the shortest possible distance to the most confident possible answer for any class from any carrier.

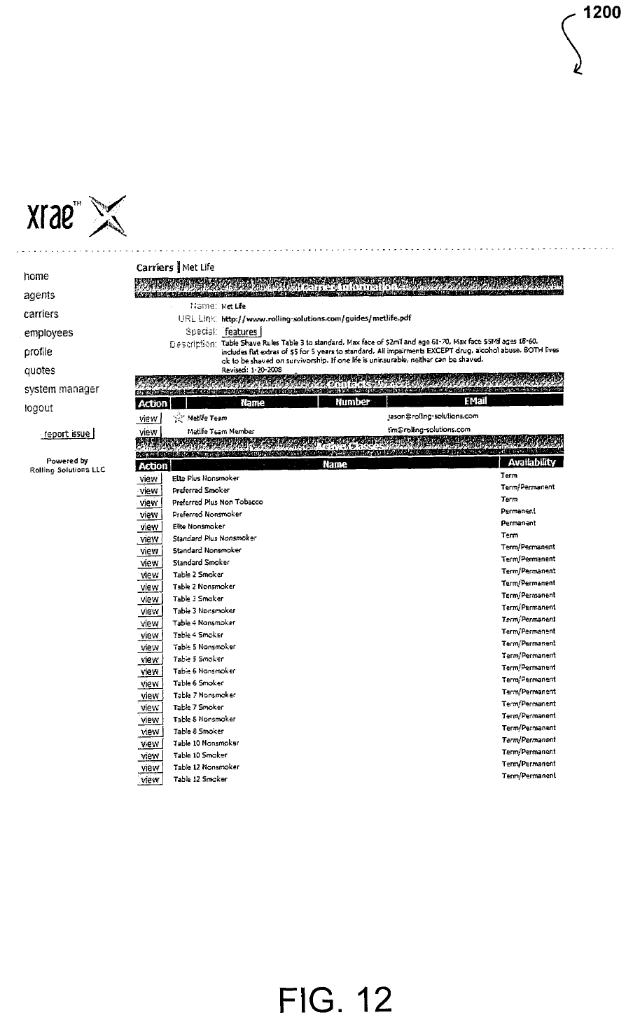

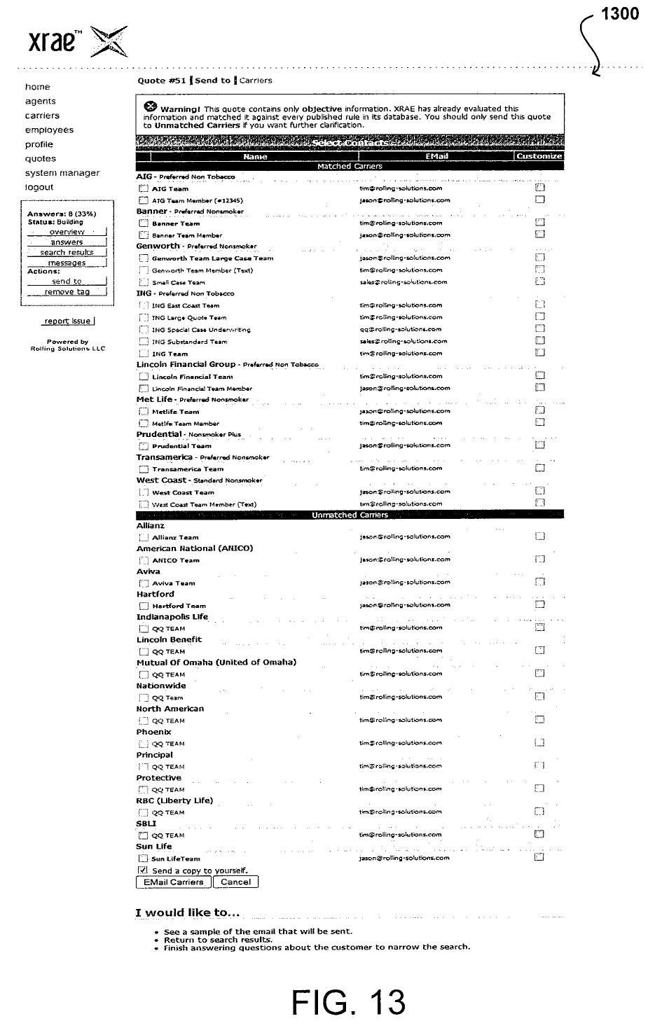

A single carrier's statistics can be viewed, such as is illustrated in the example display 1200 of FIG. 12. As quotes are sent to the carrier, XRAE records how each carrier sees each customer. This information is collected and helps build that carriers specific confidence model.

With a single click, all of recorded answers can be sent to the carriers for their input, even if the carrier is not tracked by XRAE in RML. The system can generate an email to each selected contact, such as is illustrated in the display 1300 of FIG. 13, and can send the messages out automatically or hold them back to be customized. Such an email can be sent in a carrier specific format and can include carrier specific fields if necessary. Search results can also be sent to the broker allowing for a more informed conversation about the potential customers options. Every time a quote is about to be sent to a carrier XRAE analyzes the content of the answers and attempts to determine if the quote contains any subjective information or if the XRAE search result can sufficiently address the recorded answers. This is not to replace the crucial process of human Risk Assessment, but to filter out quotes where a dedicated underwriter is not likely to find any information not already presented to the user.

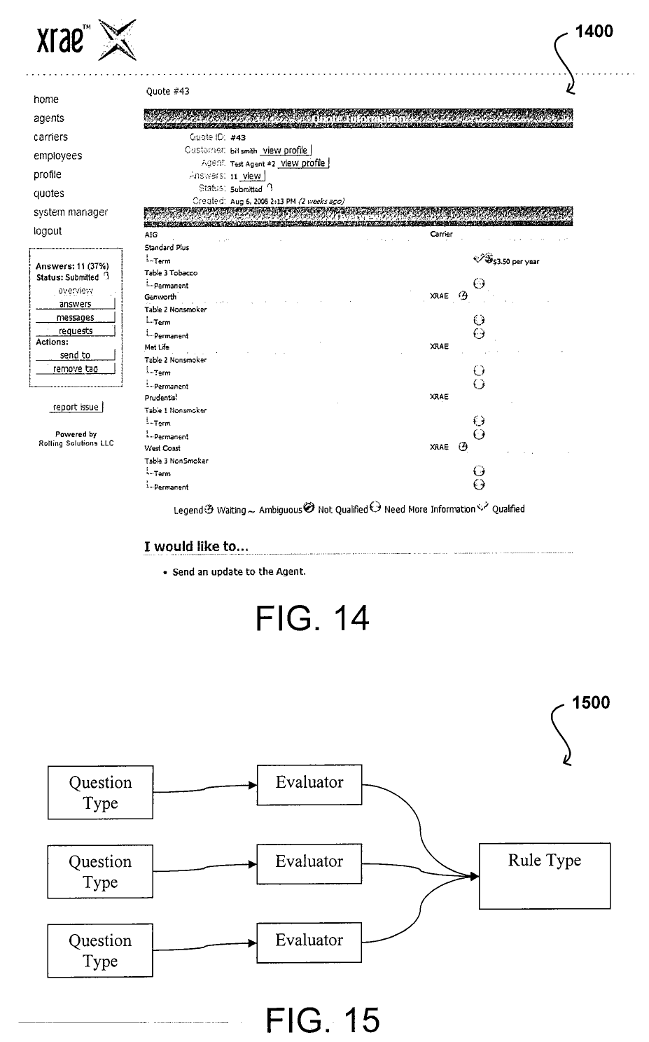

After a Quote has been submitted, the carriers' responses can be tracked. Icons can be used to denote how a carrier has responded, such as is illustrated in the example 1400 of FIG. 14. The system can also send a formatted status update to the agent via mail. A system in accordance with one embodiment utilizes an intricate separation of information and demand. Such a separation is illustrated in the example flow 1500 of FIG. 15, where different question types can be evaluated by different evaluators.

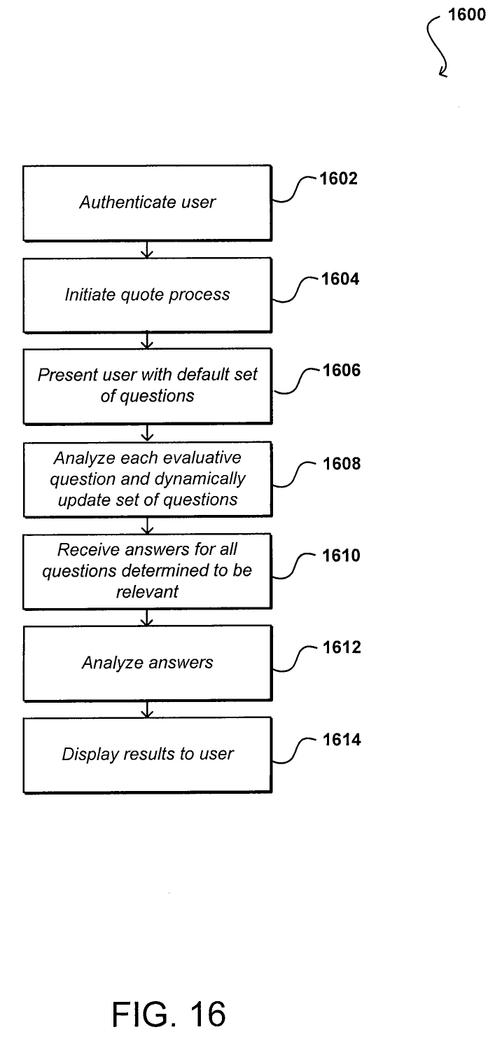

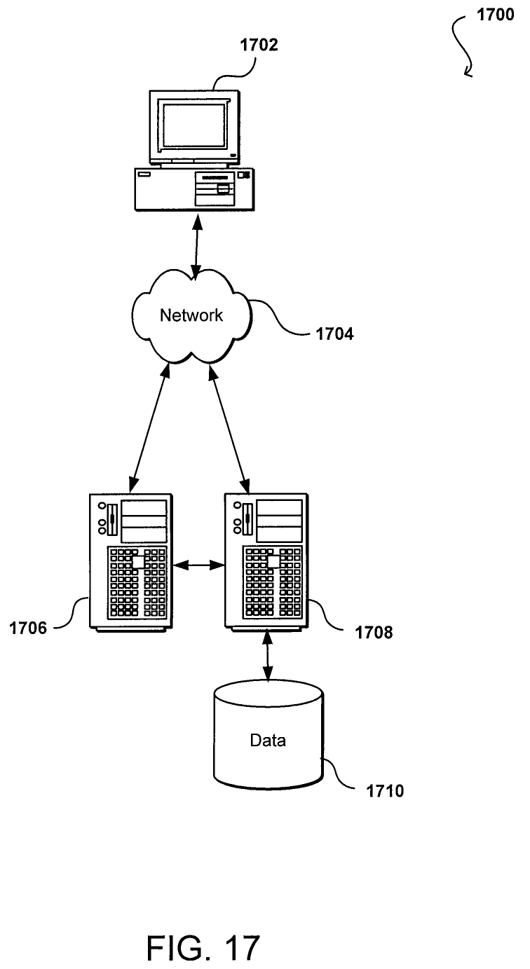

FIG. 16 illustrates a process 1600 for generating a quote in accordance with one embodiment. In this process, a user logs into the system in order to be authenticated and granted access 1602. The user then can initiate a quote generation process for a customer (or potential customer) 1604. As discussed, the user accessing the system can be any appropriate user, such as an Agent or Broker entering the information for a Customer, or in some cases even the Customer or another appropriate user. The user is presented with a default set of questions for which to enter, select, or otherwise specify information 1606. The default set of questions in this example includes a set of evaluative questions, and for each evaluative question where the user submits an answer, a process is executed to dynamically update the set of questions to be presented to a user 1608. For example, a set of business rules can be applied to the submitted answers for each evaluative (and non-evaluative) question, and based at least in part on the answers and the rules the set of default questions can be updated. In some cases, updating the set of answers will consist of adding related questions to the set of questions to be displayed to the user, and in other cases can involve removing questions and/or not changing the set of questions to be displayed. Once answers have been received for all questions in the set 1610, even after altering based on the answers and business rules, a quotation process is executed wherein the answers are analyzed using information such as carrier rates, historical data, etc., 1612. The results of the quotation process then can be displayed to the user 1614. As discussed, the results can be sorted and/or filtered using any appropriate process and/or criteria. Further, the user can be provided with only a set of information such that the user is not able to independently purchase the quoted products outside the system, and can be prevented from going back and changing information in order to get lower and/or better quoted results. The system can include logic that determines quotes generated with similar but slightly different criteria, in order to prevent people from using multiple sets of criteria for rate manipulation. When substantially similar quote requests are detected, the system can take any appropriate action, such as flagging the quote, sending a message to an administrator, locking an account of a broker, etc.

Multiple Rule Types can associate themselves with various question types and have their input processed by type specific evaluators. Object Oriented separation allows, through the use of Interfaces and Abstract Types, the ability to infinitely extend the types of questions, rules and evaluations without propagating those changes across all previous types. The trap here is the ability to over extend the solution beyond the capacity of modern computers to provide access to the service. With this in mind an initial list of types is established that provides enough flexibility to track any rule encountered thus far. Table 1 lists an example set of question types.

TABLE 1
Question types
Question Types

*Select One From List Question
*Select Any From List Question
Common Event List Question
Date(Full) Question
Date(Short) Question
Decimal Number Question
Gender Question
Height Question
Memo Question
Whole Number Question
Whole Number(Money) Question
Yes/No Question

Question types marked by a “*” are referred to herein as “meta” question types which are implemented in various ways depending on the type of list involved. For example, the “Select Tobacco Type” question is of type “Select Any from List”, which present a list of tobacco products that are tracked by XRAE and allows the user to select one or more from the list. The “Select Severity” question is of type “Select One from List” and only allows one item from the list to be selected. The separation is analogous to the different between a radio button and a checkbox in HTML. Table 2 lists various Evaluators and Table 3 lists various Rule Types that can be used with the Question types of Table 1.

TABLE 2
Evaluators
Evaluators

Common Event Approx Age (Months)
Common Event Approx Age (Years)
Common Event List Count
Count Selected
Actual Age Calculation (Years)
Approx. Age Calculation (Months)
Approx. Age Calculation (Years)
Decimal Number
Gender
Height (Feet)
Height (Inches)
Height (Meters)
Money
Nearest Age Calculation (Years)
Require Answer
Return Selected
Whole Number
Yes/No

TABLE 3
Rule Types
Rule Types

Chart Rule [Index-Range (Decimal Number)]
Chart Rule [Index-Range (Whole Number)]
Match Rule [Gender]
Match Rule [Yes/No]
Non-evaluated Rule [Memo]
Range Rule [Common Event Count]
Range Rule [Common Event Frequency]
Range Rule [Decimal Number]
Range Rule [Whole Number]
Select Rule [Explore Each]
Select Rule [Match All]
Select Rule [Match Any]
Select Rule [Match Only]
Select Rule [Weighted]

Each Question Type can be responsible for its own validation. Presentation and Input in one system are abstracted to a UI Layer so any question can be open to other input methods like XML or third Party system integration for out of process validation or data acquisition, as well as broad mobile support. A system administrator is free to create a catalog of questions based on these types. These questions become a part of the Questionnaire Engine and produce an atomized database of customer information. Questions can change type as needed allowing for subsets of the data to evolve over time.

Table 4 lists an exemplary set of Question Types. Such a list can expand into new Question Types simply by creating new types, such as types that extend IOQuestion which inherits IOQuestionInterface.

TABLE 4
Question Types

| | |
|---|---|
| Name: | Common Event List Question |
| Class: | CommonEventList |
| Description: | Renders a list of common events that have occurred over |
| | time. These events might be hospital visits, or moving |
| | violations. By associating these events with a common list, |
| | XRAE can evaluate the frequency or overall number to |
| | determine if the Customer has met or exceeded the |
| | tolerances of a specific rule. The list is also generalized so |
| | that the data can be evaluated at a later date to gain |
| | new insights. |
| Name: | Date(Full) Question |
| Class: | DateFull |
| Description: | Renders a full date (month/day/year) and evaluates for |
| | invalid dates. Uses include, date of birth and other |
| | important and specific dates where age calculation rests |
| | on the exact day. |
| Name: | Date(Short) Question |
| Class: | DateShort |
| Description: | Renders a short date (month/year) which is used primarily |
| | for approximate dates like date a customer quit smoking, |
| | or last doctor's visit. Any place where the age can be |
| | approximated to the nearest month. |
| Name: | Decimal Number Question |
| Class: | DecimalNumber |
| Description: | Renders a decimal number like Cholesterol ratio. Prevents |
| | impossible user input (non numeric characters). |
| Name: | Height Question |
| Class: | Height |
| Description: | Renders a height in inches and feet. While it has been |
| | coded for use with any abstract length, it is used |
| | exclusively for a customer's height. Evaluation is done to |
| | insure impossible user input. And its final output can be |
| | reinterpreted to any other unit of measure, so carriers can |
| | publish their guidelines using their native terms. |
| Name: | Male/Female Question |
| Class: | Gender |
| Description: | Renders a Male/Female message. It is a simple Boolean |
| | question type with context specific language. |
| Name: | Memo Question |
| Class: | Memo |
| Description: | Renders a flat text message. This is a totally non evaluated |
| | question type which is useful for capturing free text for a |
| | specific question. The answers provided are closely |
| | monitored by administrators to determine if new Question |
| | Types need to be created. |
| Name: | Whole Number Question |
| Class: | WholeNumber |
| Description: | Renders a whole number like number of cigars smoked |
| | per year. Prevents impossible user input (non numeric |
| | characters). |
| Name: | Whole Number (Money) Question |
| Class: | Money |
| Description: | Renders a whole number like face amount in common US |
| | currency format ($ prefix, comma separators and .00 |
| | suffix). Allows for the input of commas and currency signs. |
| | This class behaves a lot like the WholeNumber Question |
| | Type, and extends it for its functionality, but is unique in |
| | its input validation and rendering. |
| Name: | Yes/No Question |
| Class: | YesNo |
| Description: | Renders a Yes/No message. It is a simple Boolean |
| | question type with context specific language. |
| Name: | Abstract Select Question |
| Class: | select.* |
| Description: | The Abstract Select question allows for the recording of |
| | multiple items on a list, and the appropriate type checking |
| | and rendering without extra calls to a database. New Lists |
| | (like Personal Medical Conditions, Family Medical |
| | Conditions, Tobacco types etc all share a common |
| | evaluator function but are free to implement their |
| | input uniquely). |

The tables below illustrate other sets of types that can be used in accordance with various embodiments. A list of Rule Types can expand into new Rule Types simply by creating new types that extend IORule which inherits IORuleInterface.

TABLE 5
Chart Types

| | |
|---|---|
| Name: | Chart Rule [Index-Range (Decimal Number)] |
| Class: | chart.IndexRangeDecimalNumber |
| Outcomes: | Inside, Outside |
| Description: | Binds two questions, one that be evaluated as an Integer |
| | (the index question) and one that can be evaluated as |
| | Float (the Range question). A series of acceptable ranges |
| | can be defined for discrete index values. |
| Name: | Chart Rule [Index-Range (Whole Number)] |
| Class: | chart.IndexRangeWholeNumber |
| Outcomes: | Inside, Outside |
| Description: | Binds two questions, can both be that be evaluated as |
| | Integers (the index and the range questions) A series of |
| | acceptable ranges can be defined for discrete index values. |
| | This is commonly used for build charts where a height is |
| | compared to an acceptable weight range. |

TABLE 6
Match Types

| | |
|---|---|
| Name: | Match Rule [Gender] |
| Class: | match.Gender |
| Outcomes: | Male, Female |
| Description: | Binds to a gender question and produces what ever |
| | outcome that matches the answer provided. This is |
| | commonly a parent rule to other child rules allowing for |
| | gender specific evaluation for things like build or personal |
| | medical history. |
| Name: | Match Rule [Yes/No] |
| Class: | match.YesNo |
| Outcomes: | Yes, No |
| Description: | Binds to a yes/no question and produces what ever outcome |
| | that matches the answer provided. This is commonly a |
| | parent rule to other child rules allowing for specific |
| | evaluation for things like family medical history and |
| | condition fatality. |

TABLE 7
Range Types

| | |
|---|---|
| Name: | Range Rule [Common Event Count] |
| Class: | range. CommonEventCount |
| Outcomes: | Less Than, Inside, Greater Than |
| Description: | Takes a common event list and determines if the number of |
| | events with an age of at least some designated vale exceeds |
| | a tolerance value. The individual events are all evaluated by |
| | a designated Short Date Evaluator. |
| Name: | Range Rule [Common Event Frequency] |
| Class: | range. CommonEventFrequency |
| Outcomes: | Less Than, Inside, Greater Than |
| Description: | Takes a common event list and determines of the frequency |
| | over time exceeds a tolerance value. The individual events |
| | are all evaluated by a designated Short Date Evaluator. |
| Name: | Range Rule [Decimal Number] |
| Class: | range.DecimalNumber |
| Outcomes: | Less Than, Inside, Greater Than |
| Description: | Takes any question that can be evaluated to a Float and |
| | determines if its answer is Less Than, Inside or Greater |
| | Than a configured value. |
| Name: | Range Rule [Whole Number] |
| Class: | range.WholeNumber |
| Outcomes: | Less Than, Inside, Greater Than |
| Description: | Takes any question that can be evaluated to an Integer and |
| | determines if its answer is Less Than, Inside or Greater |
| | Than a configured value. |

TABLE 8
Select Types

| Name: | Select Rule [Explore Each] | | | | | |
|---|---|---|---|---|---|---|
| Class: | select.ExploreEach | | | | | |
| Outcomes: | Generates outcomes for each selected item from the configured | | | | | |
| | list | | | | | |
| Description: | Binds to a Select List Question type can generates outcomes for | | | | | |
| | each user selected item. It can also be configured to track the | | | | | |
| | subsequent passing and failing of each child decision tree bound | | | | | |
| | to each outcome, and can generate it's own pass or fail based on | | | | | |
| | which mode it is in. | | | | | |
| Name: | Select Rule [Match All] | | | | | |
| Class: | select.MatchAll | | | | | |
| Outcomes: | None, All | | | | | |
| Description: | Determines if all selected items on a specific list match the | | | | | |
| | selected items provided by the answer to the bound question. | | | | | |
| | Selected items from the answered question that are outside of the | | | | | |
| | configured selected items are safely ignored. This chart explains | | | | | |
| | the concept. | | | | | |
| | Rule | | | | | |
| | None | Cigarettes | Cigars | Chew | Other | Outcome |
| | | X | X | | | |
| | Answer | | | | | |
| | | | X | X | | None |
| | | X | X | | | All |
| | | X | X | X | | All |
| Name: | Select Rule [Match Any] | | | | | |
| Class: | select.MatchAny | | | | | |
| Outcomes: | None, Any | | | | | |
| Description: | Determines if all selected items on a specific list match the | | | | | |
| | selected items provided by the answer to the bound question. | | | | | |
| | Selected items from the answered question that are outside of the | | | | | |
| | configured selected items are safely ignored. This chart explains | | | | | |
| | the concept. | | | | | |
| | Rule | | | | | |
| | None | Cigarettes | Cigars | Chew | Other | Outcome |
| | | | X | X | | |
| | Answer | | | | | |
| | | | | X | X | None |
| | | X | X | | | Any |
| | | | X | X | | Any |
| | | X | X | X | | Any |
| Name: | Select Rule [Match Only] | | | | | |
| Class: | select.MatchOnly | | | | | |
| Outcomes: | None, Match | | | | | |
| Description: | Determines if all selected items on a specific list match the | | | | | |
| | selected items provided by the answer to the bound question. | | | | | |
| | Selected items from the answered question that are outside of the | | | | | |
| | configured selected items are safely ignored. This chart explains | | | | | |
| | the concept. | | | | | |
| | Rule | | | | | |
| | None | Cigarettes | Cigars | Chew | Other | Outcome |
| | | | X | X | | |

Answer

| | | | | |
|---|---|---|---|---|
| | | X | X | None |
| X | X | | | Match |
| | X | X | | None |
| X | X | X | | None |

| | |
|---|---|
| Name: | Select Rule [Weighted] |
| Class: | select.Weighted |
| Outcomes: | Less Than, Inside, Greater Than |
| Description: | Allows the administrator to assign values (or Weights) to each |
| | item on a list. The total weight is of an answer is determined by |
| | adding up the weight of each selected item. This value is then |
| | compared to a configured range. This Rule type is used to define |
| | sub communities of acceptable and unacceptable items within a |
| | singe list. For Questions like the Personal Medical History |
| | question (with 42 possible conditions that form 9.09334 × 10⁴⁹ + |
| | 1 possible permutations, as None is not selectable with any other |
| | item) this greatly simplifies handling of combinations. |

While the examples described herein refer mainly to insurance quotations, it should be understood that these are merely exemplary and should not be interpreted as limiting the scope of the disclosure. Any industry where quotations or estimates are provided based on various information can taken advantage of certain approaches described herein as would be apparent to one of ordinary skill in the art in light of the teachings and suggestions contained herein.

Systems, methods, and other approaches described and suggested herein can operate in an environment such as the environment 1700 illustrated in FIG. 7. As shown, such an environment can include one or more user computers 1702, computing devices, or processing devices, which can be used to operate a client, such as may execute computer program code including instructions for generating and operating a dedicated application, web browser, etc. The user computers can be general purpose personal computers (including, merely by way of example, personal computers and/or laptop computers running a standard operating system), cell phones or PDAs (running mobile software and being Internet, e-mail, SMS, Blackberry, or other communication protocol enabled), workstation computers running any of a variety of commercially-available UNIX or UNIX-like operating systems (including without limitation, the variety of GNU/Linux operating systems), as a thin-client computer, Internet-enabled gaming system, and/or personal messaging device, capable of communicating via a network and/or displaying and navigating Web pages or other types of electronic documents.

In most embodiments, the system includes some type of network 1704. The network may be any type of network familiar to those skilled in the art that can support data communications using any of a variety of commercially-available protocols, including without limitation TCP/IP, SNA, IPX, and the like. The system may also include one or more server computers 1706, 1708 which can be general purpose computers, specialized server computers (including, merely by way of example, PC servers, UNIX servers, mid-range servers, mainframe computers rack-mounted servers, etc.), server farms, server clusters, or any other appropriate arrangement and/or combination. A Web server, for an Internet-based environment, for example, can run an operating system including any of those discussed above, as well as any commercially-available server operating systems. The Web server can also run any of a variety of server applications and/or mid-tier applications, including HTTP servers, FTP servers, CGI servers, database servers, Java servers, business applications, and the like. The system may also include one or more databases 1710 residing in any of a variety of locations. Similarly, any necessary files for performing the functions attributed to the computers may be stored locally on the respective computer and/or remotely, as appropriate. In one set of embodiments, the database is a relational database adapted to store, update, and retrieve data in response to SQL-formatted commands. Such a system also can include an application server, for example, which can include a processor that is able to execute computer-readable instructions stored in a storage medium or computer-readable medium and perform specified operations, etc.

Storage media and computer readable media for containing code, or portions of code, can include any appropriate media known or used in the art, including storage media and communication media, such as but not limited to volatile and non-volatile, removable and non-removable media implemented in any method or technology for storage of information such as computer readable instructions, data structures, program modules, or other data, including RAM, ROM, EEPROM, flash memory or other memory technology, CD-ROM, digital versatile disk (DVD) or other optical storage, magnetic cassettes, magnetic tape, magnetic disk storage or other magnetic storage devices, or any other medium which can be used to store the desired information and which can be accessed by the computer, processor, etc. Based on the disclosure and teachings provided herein, a person of ordinary skill in the art will appreciate other ways and/or methods to implement the various embodiments.

The specification and drawings are, accordingly, to be regarded in an illustrative rather than a restrictive sense. It will, however, be evident that various modifications and changes may be made thereunto without departing from the broader spirit and scope of the disclosure as set forth in the claims.

What is claimed is:

1. A method of providing quote information from at least one of multiple entities, comprising:
selecting a first set of questions to be displayed to a user, the first set of questions including at least one evaluative question;
receiving input from the user in response to at least a portion of the first set of questions;
for each evaluative question, analyzing the input for that question and updating the set of questions to be displayed to the user;
once input has been received for each question in the updated set of questions, analyzing the input using at least one business rule to determine quote information for at least one of the multiple entities; and
generating the quote information for display to the user.

2. A method according to claim 1, further comprising:
sorting the quote information to be displayed to the user using confidence information.

3. A method according to claim 1, wherein:
each evaluative question corresponds to a node of a question hierarchy, and
certain branches of the question hierarchy include questions that are only added to the set of questions based upon a specific answer to a respective evaluative question.

4. A method according to claim 3, wherein:
each branch includes at least one of an evaluative question and an non-evaluative question.

5. A method according to claim 1, further comprising:
storing the quote information and the user input for future analysis.

6. A method according to claim 1, further comprising:
determining a progress level of the user after receiving input from the user; and
causing the progress level to be displayed to the user.

7. A method according to claim 1, wherein:
the quote information includes a set of classes each used in determining a rate.

8. A method according to claim 1, further comprising:
enabling a user to update questions able to be presented to the user; and
enabling the user to specify dependencies for each question in a hierarchy of questions.

9. A method according to claim 1, further comprising:
enabling the user to submit the information to at least one of the entities to receive a specific quote from that entity.

10. A method according to claim 1, further comprising:
withholding at least a portion of the quote information from the user such that the user is not able to independently use the quote information to purchase a product or service.

11. A method according to claim 1, further comprising:
restricting a user from changing an answer to any of the updated set of questions after having the quote information displayed.

12. A method according to claim 1, further comprising:
monitoring accuracy of the quote information over time.

13. A system for providing quote information from at least one of multiple entities, comprising:
a processor; and
a storage medium including instructions that, when executed by the processor, cause the processor to:
select a first set of questions to be displayed to a user, the first set of questions including at least one evaluative question;
receive input from the user in response to at least a portion of the first set of questions;
for each evaluative question, analyze the input for that question and updating the set of questions to be displayed to the user;
once input has been received for each question in the updated set of questions, analyze the input using at least one business rule to determine quote information for at least one of the multiple entities; and
generate the quote information for display to the user.

14. A system according to claim 13, wherein the storage medium further includes instructions that, when executed by the processor, cause the processor to:
cause certain questions to only be added to the set of questions based upon a specific answer to a respective evaluative question, each evaluative question corresponding to a node of a question hierarchy.

15. A system according to claim 13, wherein the storage medium further includes instructions that, when executed by the processor, cause the processor to:
determine a progress level of the user after receiving input from the user; and
cause the progress level to be displayed to the user.

16. A system according to claim 13, wherein the storage medium further includes instructions that, when executed by the processor, cause the processor to:
enable the user to submit the information to at least one of the entities to receive a specific quote from that entity.

17. A system according to claim 13, wherein the storage medium further includes instructions that, when executed by the processor, cause the processor to:
withhold at least a portion of the quote information from the user such that the user is not able to independently use the quote information to purchase a product or service.

18. A computer program product embedded in a computer-readable medium for providing quote information from at least one of multiple entities, comprising:
program code for selecting a first set of questions to be displayed to a user, the first set of questions including at least one evaluative question;
program code for receiving input from the user in response to at least a portion of the first set of questions;
program code for analyzing the input for each evaluative question and updating the set of questions to be displayed to the user;
program code for, once input has been received for each question in the updated set of questions, analyzing the input using at least one business rule to determine quote information for at least one of the multiple entities; and
program code for generating the quote information for display to the user.

19. A computer program product according to claim 18, further comprising:
program code for causing certain questions to only be added to the set of questions based upon a specific answer to a respective evaluative question, each evaluative question corresponding to a node of a question hierarchy.

20. A computer program product according to claim 18, further comprising:
program code for determining a progress level of the user after receiving input from the user; and
program code for causing the progress level to be displayed to the user.
